(19) United States
(12) Patent Application Publication
(10) Pub. No.: US 2002/0014392 A1
(43) Pub. Date: Feb. 7, 2002

(54) Vertical conveyor

(76) Inventor: Johann Walter Grond, Emden (DE)

Correspondence Address: COLLARD & ROE, P.C., 1077 Northern Boulevard, Roslyn, NY, 11576-1696, US

(21) Appl. No.: 09/865,270

(22) Filed: May 25, 2001

(30) Foreign Application Priority Data
May 25, 2000 (DE) 100 26 346.1

(51) Int. Cl. B65G 37/00

(52) U.S. Cl. 198/610

(57) ABSTRACT

A vertical conveyor for transporting a load in a warehouse equipped with shelves. This vertical conveyor comprises a plurality of receiving devices spaced apart from one another. These receiving devices receive a load and can be displaced vertically. There are also a series of stationary transport elements disposed adjacent to the plurality of receiving devices in an alternating manner. The plurality of receiving devices can comprise driven rollers while the series of stationary transport elements can also comprise driven rollers.

### BACKGROUND OF THE INVENTION

1. Field of the Invention

The invention relates to a vertical conveyor for transporting a load in a warehouse equipped with stocking shelves.

2. The Prior Art

Such shelf warehouses have been served until now with the help of forklift trucks and/or floor conveyor devices that can be operated partly by hand and partly in an automated manner. It is necessary in conjunction with such stockkeeping systems to always also move together with the load to be transported a transporting device having a high dead weight. This requires a relatively high expenditure in terms of energy and the possible speed is restricted.

For automating such a warehouse facility to a high degree it is particularly necessary to install a vertical conveyor that is largely operating in an automatic manner.

### SUMMARY OF THE INVENTION

Therefore, the invention is based on the problem of providing a vertical conveyor of the type specified above that it suitable for being employed in an automatically operated shelf-equipped warehouse. Said problem is solved with a vertical conveyor with the features specified in patent claim 1. Advantageous further developments of the invention are specified in the dependent claims.

According to the basic idea of the invention, a vertical conveyor is designed in such a way that it comprises a plurality of receiving devices that are arranged spaced from one another, whereby such receiving devices are designed for receiving a load, and the receiving devices so spaced from one another can be jointly displaced in the vertical direction. The transfer of a load is possible in a particularly easy manner with such a vertical conveyor because loads can be transferred with the help of additional elements in an especially easy way with the help of such elements, which are arranged between said spaced-apart receiving devices. The overall purpose off such receiving devices is to safely support loads that are preferably arranged in two parallel rows, on which the overall load rests in a safe manner. The transported loads may be collies, pallets or other forms of loads. The loads are favorably positioned on a transport pallet.

According to a preferred advanced development of the invention, the receiving devices are driven, so that the load can be transported in the horizontal direction. It is particularly possible in this way to simply transport a load into the vertical conveyor and to then to remove it from the latter. Provision is favorably made for said purpose for revolving belts that connect the individual receiving devices with each other and in this way assure that the load resting on the receiving devices is uniformly advanced.

According to another advanced development of the invention, the vertical conveyor has transport elements that are disposed in a stationary manner at least at one level. Said level preferably is the basic level or the floor on which the loads are delivered to the shelf warehouse and loaded on the vertical conveyor, because when such stationary transport elements are employed it is possible to transport loads also on the basic or some other level if the vertical conveyor is not positioned at said level, so that the vertical conveyor can transport a load to the top level (or tier) of the shelf warehouse, on the one hand, and loads can be further transported at the same time to rows located in the rear at the basic level, on the other. The stationary transport elements are preferably arranged spaced from each other as well, so that other elements and in particular the receiving devices can be placed between said transport elements. It is particularly preferred that the receiving devices and the transport elements are arranged in an alternating manner, so that a nearly through-extending surface is formed at the moment the vertical conveyor is located at the level of the transport elements.

Furthermore, it is favorable if the receiving devices can be lowered to slightly below the level of the transport elements. It is possible in this way to push a load onto the transport elements without causing the receiving devices to interfere with the movement of the movable part of the vertical conveyor. When said vertically movable part of the vertical conveyor is in said lowered position, it can be maintained there in sort of an idle (or resting) position without interfering with the horizontal movement taking place above at the basic level where the loads are delivered to the individual rows of shelves.

According to a preferred embodiment of the invention, the receiving devices are substantially formed by driven rollers. The transport elements are favorably designed in the form of rollers as well, so that a through-extending row of rollers is formed within the range of the vertical conveyor, such rollers being arranged in such a way that each stationary roller is alternating with a roller that can be driven up together with the vertical conveyor. Other embodiments of the receiving devices and transport elements can be basically realized as well. For example, said devices and elements may be realized in the form of conveyor belts or sliding elements.

The vertical conveyor is preferably arranged in the shelf warehouse in a row of shelves, so that the load is charged in the vertical conveyor, conveyed in the latter upwards, and then comes to rest in an upper row of shelves parallel with a shelf compartment, so that an automatic load removal systems accesses the vertical conveyor in the same way as all other shelf compartments present in the that row next to it. Therefore, the vertical conveyor is not arranged in the runway between two rows of shelves, but rather in a row of shelves, preferably at one end of a row of shelves. However, it is conceivable also that the row of shelves is extended on both sides of the vertical conveyor.

According to yet another advanced development of the invention, the receiving devices are designed in such a way that they can be folded away, so that such devices will not reach up to their actual transport position but can be folded up or down without interfering with a load passing through. It is conceivable also that the receiving devices can be retracted or pulled away sideways.

According to another preferred advanced development of the invention, provision is made at each level of the vertical conveyor for a roller track that can be folded down, whereby such a roller track corresponds with the transport elements of the lower level. When a load is then steered to a certain level, the vertical conveyor can be driven first into a position slightly below such a defined level without requiring any entirely exact and complicated positioning of the conveyor. As soon as the load has reached the desired area, the folded down transport elements forming a roller track are folded up and the vertical conveyor is then driven down and deposits the load on the transport elements. The warehouse stocking operation can be further accelerated in this manner.

### BRIEF DESCRIPTION OF THE DRAWINGS

Other objects and features of the present invention will become apparent from the following detailed description considered in connection with the accompanying drawings which disclose several embodiments of the present invention. It should be understood, however, that the drawings are designed for the purpose of illustration only and not as a definition of the limits of the invention.

In the drawings, wherein similar reference characters denote similar elements throughout the several views:

FIG. 1 is a cut top view of the basic level of a warehouse equipped with stocking shelves;

FIG. 2 is a top view of a vertical conveyor as defined by the invention;

FIG. 3 is a cut side view of a vertical conveyor as defined by the invention;

FIG. 4 is a cut side view of a vertical conveyor as defined by the invention, shown with a lifted load; and

FIG. 5 is a cut side view of a vertical conveyor as defined by the invention shown in another operating position.

### DETAILED DESCRIPTION OF PREFERRED EMBODIMENTS

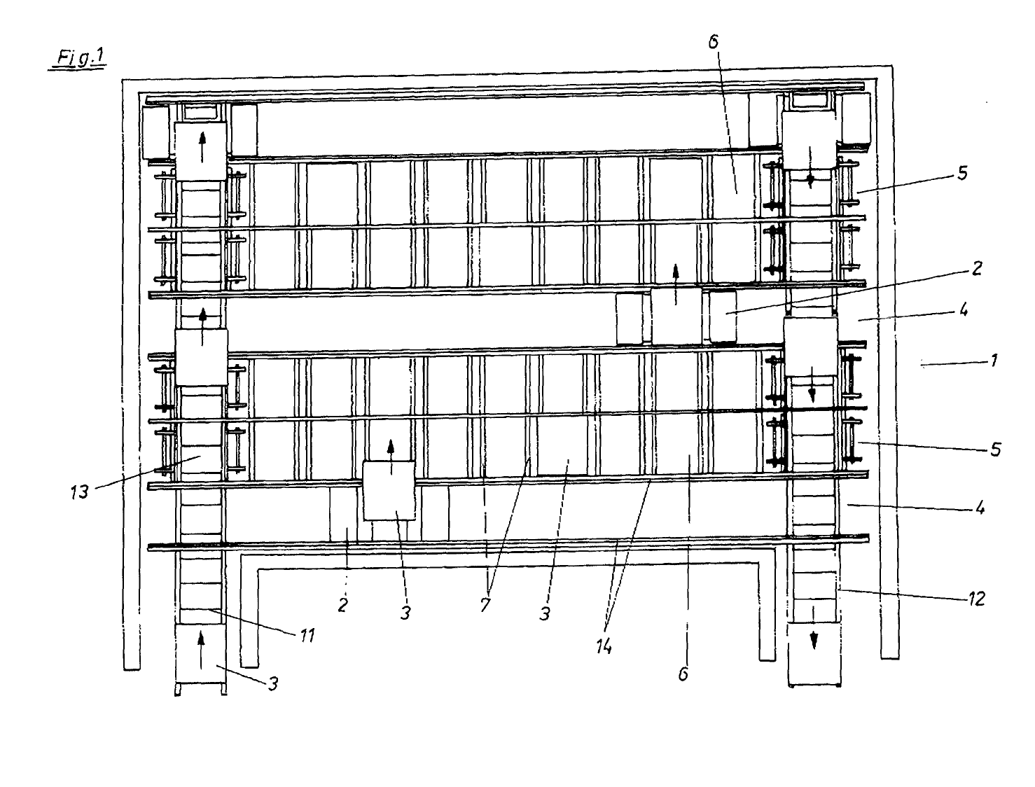

FIG. 1 is a tip view of the basic level of a shelf warehouse 1, where loads are stocked in and removed from the shelf locations 6 or shelf compartments. In such a stockkeeping operation, the loads 3 are transported on a stocking track 11 and delivered into the shelf warehouse 3 and transported out of the shelf warehouse on a load removal track 12. The shelf warehouse 1 comprises the shelf runways 4 and the rows 5 of shelves. The loads 3 are first transported on the stocking track 11 to the vertical conveyors located at the ends of the shelf rows 5 and then raised with said vertical conveyors 13 to the desired level of the shelf warehouse. At said level, the loads are removed from the vertical conveyor 13 with the transport devices 2 running on the rails 14 along the shelf runway 4, removed from the vertical conveyor 13, transported along the self runway 4, and then delivered to the desired shelf location 4. Each shelf location (or space) has two parallel rows of guides, on which the load 3 is transferred from the transport device 2 to the shelf location 6. The shelf loading track 1 also can be used as a combined load stocking and load removal track, in which case the additional load removal track 12 is not needed. Furthermore, the warehouse can be expanded on the other side of the shelf stocking track 11, in which case the vertical conveyor 3 will be arranged in the center of a shelf row 5.

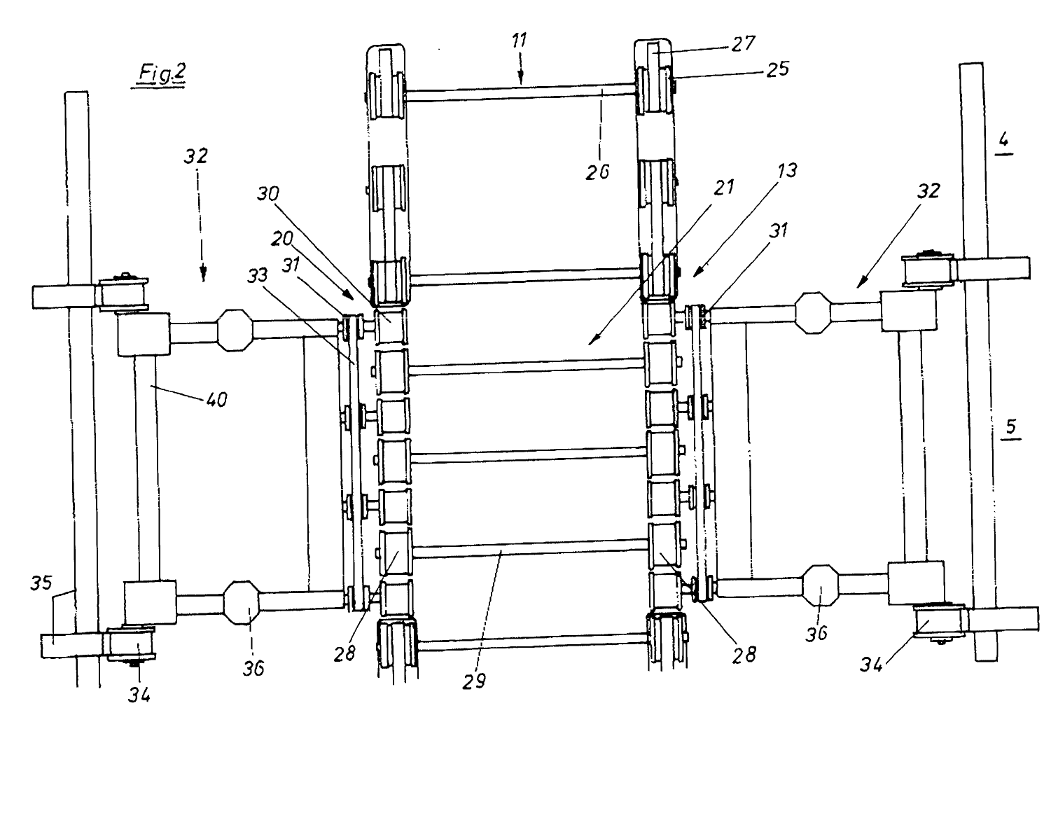

FIG. 2 shows a top view of the vertical conveyor 13 located in its starting position. The vertical conveyor 13 is operated on the shelf stocking track 11, which is intersected by the shelf row 5 at a right angle. The vertical conveyor 13 is installed in said site of intersection. A shelf runway 4 extends parallel with the shelf row 5. The shelf stocking track 11 comprises the rollers 25, which are connected with each by the belts 27 and driven. Said rollers form pairs of rollers that are connected with each other by the axles 26. A shelf stocking track 11 is formed in that way that comprises two rows of roller drives. A load 3 rests on said drives and is transported by the rollers 25 or pairs of rollers along the shelf stocking track, and then arrives at the vertical conveyor 13. The vertical conveyor 13 comprises the vertically movable receiving devices 20 and the stationary transport elements 21. The stationary transport elements 21 are substantially realized in the form of the rollers 28 as well, and connected with each other by the axles 29. Said rollers are arranged as a continuation of the line of the shelf stocking track 11. A spacing is provided between each two of the individual rollers 20, so that an intermediate space remains available in which the receiving devices are arranged, said receiving devices being realized in the form of the rollers 30 as well. In the exemplified embodiment shown, provision is made for two times the three rollers 28, thus for a total of six rollers 28 forming the transport elements, and for two times the four rollers 30, which can be raised vertically and thus substantially form the receiving devices 20. Said rollers are arranged in a manner in which they alternate with each other, so that overall a through-extending row of rollers is available in the shelf stocking track 11. The rollers 30 are secured via the axles 31 on the conveyor element 32 and are jointly driven by a driving belt 33. The rollers 30 of the receiving device 20 are arranged in each case directly adjacent to one of the rollers 25 of the shelf stocking track 11. Said rollers 30 are driven and therefore are capable of providing for continuous further transport. Thus provision is made on each side of the vertical conveyor 13 for a conveyor element 32 that can be displaced vertically upwards via the rollers 34 on a lever system 35 of a warehouse equipped with shelves. The conveyor elements 32 comprise the joints 36, by means of which the front section of the conveyor elements 32 with the receiving devices 20 can be folded away downwards.

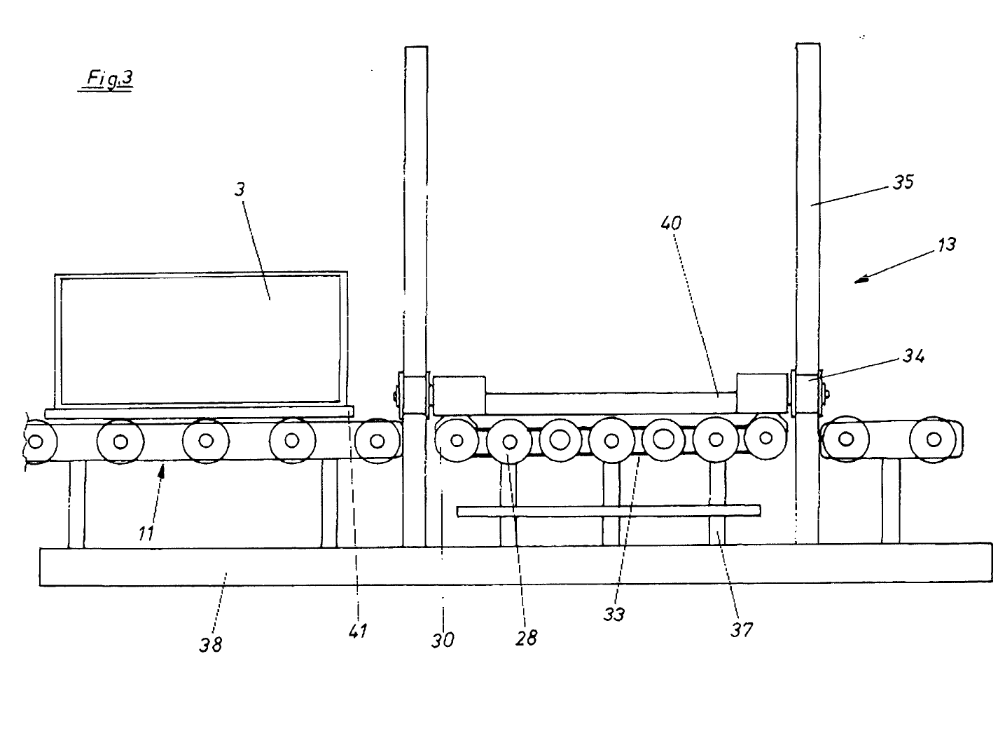

FIG. 3 shows a cut side view of the vertical conveyor 13. Identical elements are denoted by the same reference numerals. The rollers 28 of the transport elements 21 are arranged on the floor 38 of the shelf warehouse by means of the vertical struts 37. A load placed on a transport pallet 41 is delivered to the vertical conveyor 13 via the shelf stocking track 11. In said operation, the rollers 30 of the receiving device 20 are first located at about the same level as the rollers 28 of the transport elements 21. The receiving device 20 can be lowered also below the level of the transport elements 21 in order to make it easier to push on the transport pallet 41.

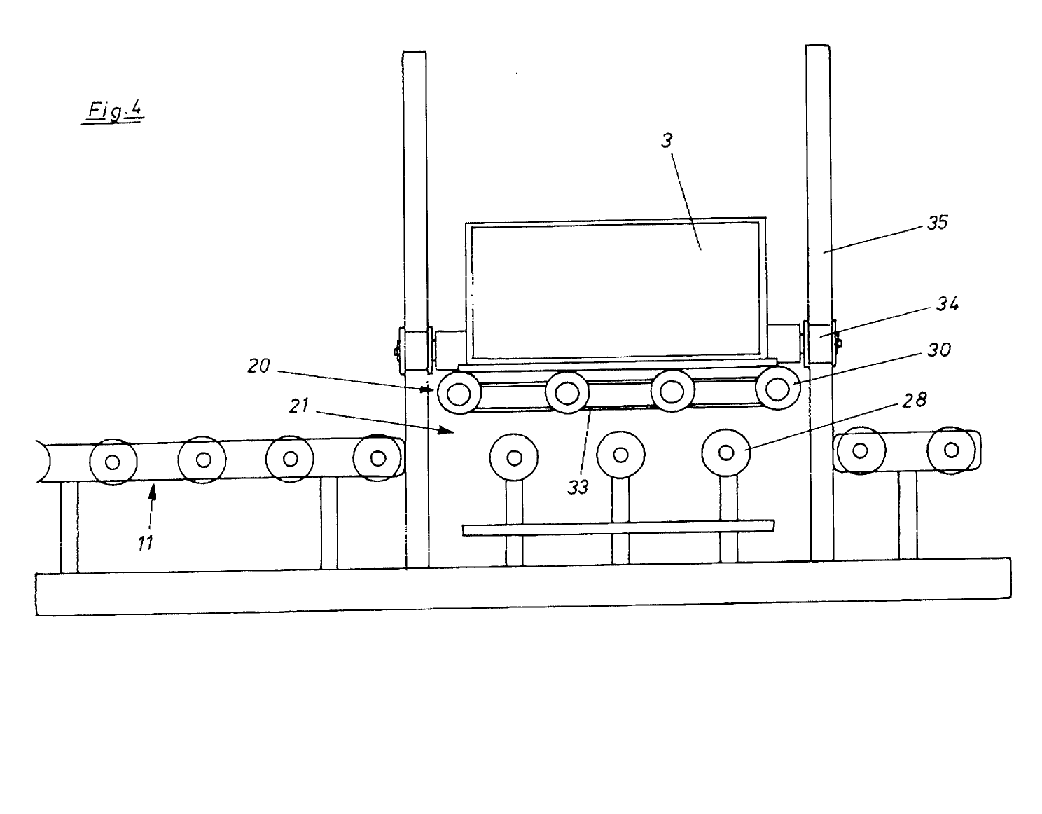

FIG. 4 is another side view of the vertical conveyor, showing that the vertical conveyor has now raised the load 3.

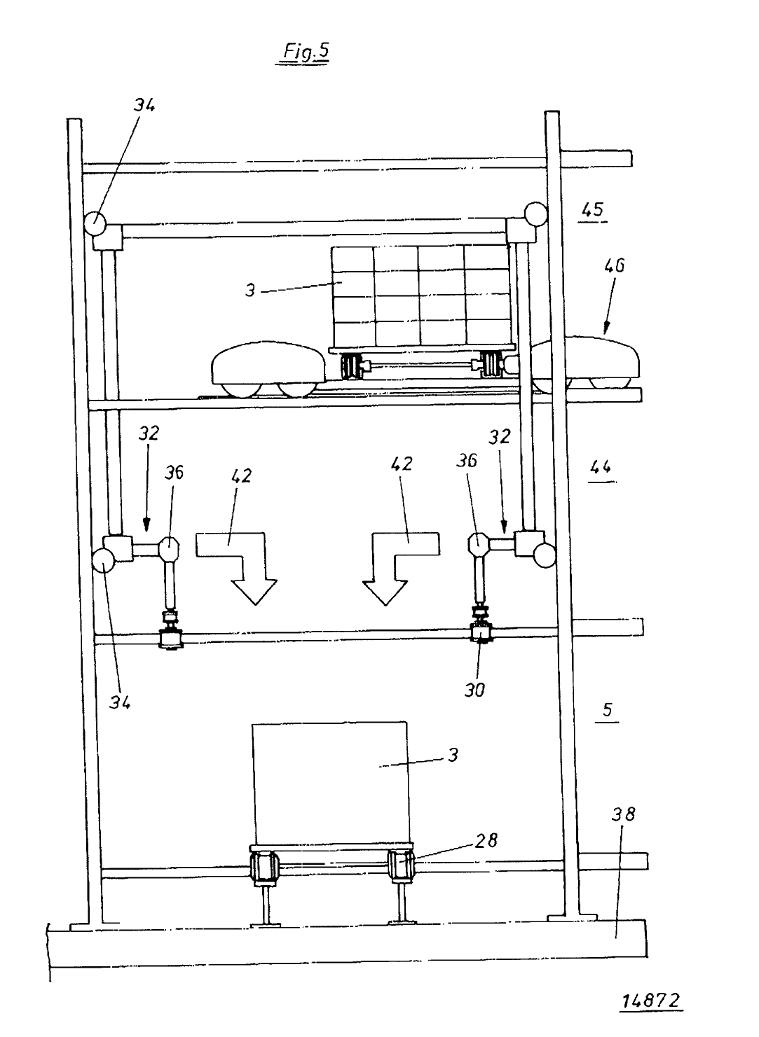

FIG. 5 shows a cut side view that has been turned by 90° versus FIGS. 3 and 4. Visible are the different levels 4, 44 and 45 of the shelf warehouse, whereby the vertical conveyor 13, or at least the movable part of said vertical conveyor 13 has been driven up. At the upper level, a load 3 is driven next to the vertical conveyor on the runway 5 located next to the vertical conveyor with the help of a transport carriage 46, and can be loaded from there on the vertical conveyor 13 as into a shelf compartment. The arrows 42 indicate that the front part of the conveyor elements 32 has been folded down on the joint 36, so that the rollers 30 are suspended, hanging down. The joint 36 is positioned in such a way that the part of the conveyor element 32 that is folded down is adequately large for creating a clear inner space that is wider than a load 3. The vertical conveyor 13 can be driven down, whereby the rollers 30 are first swivelled again up on the joint 36 only then, and then take hold of the load. 3 from the bottom, said load already waiting in the shelf-stocking position. The spacing between the rollers 28 of the transport elements and the floor 38 of the shelf warehouse is adapted to the space required by said swiveling movement.

Accordingly, while a few embodiments of the present invention have been shown and described, it is to be understood that many changes and modifications may be made thereunto without departing from the spirit and scope of the invention as defined in the appended claims.

What is claimed is:

1. A vertical conveyor for transporting a load in a warehouse equipped with shelves, wherein the vertical conveyor comprises:
a plurality of receiving devices spaced from one another, wherein said receiving devices receive a load and wherein said receiving devices can be displaced vertically.

2. The vertical conveyor according to claim 1, wherein said plurality of the receiving devices are driven, so that said load can be conveyed horizontally.

3. The vertical conveyor according according to claim 1, wherein the vertical conveyor further comprises a series of stationary transport elements.

4. The vertical conveyor according to claim 3, wherein said series of stationary transport elements is spaced apart from each other.

5. The vertical conveyor according according to claim 1, wherein said plurality of receiving devices and said series of stationary transport elements are arranged in an alternating manner.

6. The vertical conveyor according to claim 3, wherein said plurality of receiving devices can be lowered below said series of stationary transport elements.

7. The vertical conveyor according to claim 1, wherein said plurality of receiving devices comprises driven rollers.

8. The vertical conveyor according to claim 3, wherein said series of stationary elements comprises driven rollers.

9. The vertical conveyor according to claim 1, wherein the vertical conveyor is arranged in a shelf warehouse in a row of shelves.

10. The vertical conveyor according to claim 1, wherein said plurality of receiving devices can be folded away.
